(19) United States
(12) Patent Application Publication
(10) Pub. No.: US 2007/0159004 A1
(43) Pub. Date: Jul. 12, 2007

(54) TRACTION BAND WITH IMPROVED GROUND-ENGAGING LUGS

(76) Inventor: Pascal St-Amant, Drummondville (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/615,641

(22) Filed: Dec. 22, 2006

(30) Foreign Application Priority Data
Jan. 6, 2006 (CA) 2,532,292

(51) Int. Cl. B62D 55/00

(52) U.S. Cl. 305/165

(57) ABSTRACT

A traction band with improved ground-engaging lugs is disclosed. The traction band generally comprises an endless body extending along the longitudinal axis of the traction band. The body comprises an outer ground-engaging surface and an inner sprocket wheel engaging surface. The inner sprocket wheel engaging surface can comprise rows of drive lugs cooperating with the sprocket wheel. The outer ground-engaging surface comprises a series ground-engaging lugs which, according to the present invention, have a generally H-shape, I-shape, C-shape, O-shape or a rectangular shape when viewed from the top.

### FIELD OF THE INVENTION

The present invention relates to an endless traction band or track that is used to propel track laying vehicles. More particularly, the present invention relates to a traction band with improved ground-engaging lugs.

### BACKGROUND OF THE INVENTION

Traction band for use on snowmobile, wheel-replacement traction kit, skid-steer and other well known track laying equipments and vehicles are known in the art and their uses increase with each passing year. The use of these traction bands allow track-laying vehicles to travel over soft, muddy, snowy, sandy and other similar terrain.

In the case of traction bands for snowmobile, numerous improvements have been done throughout the years to enhanced the performance, the resistance, the rigidity, the noise profile and other characteristics of these bands.

Nowadays, traction bands, especially for snowmobiles, are known to comprise transverse reinforcing rods or stiffeners to rigidify the band, specific clip and/or holes patterns to reduce the noise generated by the band, adapted drive lugs and corresponding sprocket wheels to improve the transmission of power between the motor and the band. Even the material of the bands themselves, far from being only rubber, now comprises steel cords, fabrics, Kevlar™ and other composite reinforcing material.

Nevertheless, the transmission of the power of the motor to the ground ultimately depends on the ground-engaging lugs which effectively contact the ground. Some improvements have been proposed in recent years. For example, the Applicants proposed, in co-pending U.S. patent application Ser. No. 10/414,557, a snowmobile traction band which comprises ground-engaging or traction lugs with specific profiles to reduce the wear of the traction band and improve the handling of the vehicle.

In U.S. Pat. Nos. 6,505,896 and 6,609,771, we can see two different traction lugs configurations which are respectively designed to be higher and bulkier. These traction bands provide a better traction but with a corresponding increase in the weight of the track.

U.S. Pat. No. 6,626,258, granted to Forbes, is probably the closest prior art of the present invention. The traction lugs of Forbes comprise rigidifying portions which are generally transverse with respect to the lugs.

However, in the prior art, in order to improve the rigidity and the resistance of the traction lugs, the usual method was to enlarge the lugs and to make them higher. The net results were indeed stronger lugs but also a heavier traction band which, in the end, is more costly and less efficient.

There is therefore a need to improve the design of the ground-engaging lugs of traction bands to enhance the resistance and the rigidity of these lugs without increasing their size and thus the weight of the band.

### OBJECTS OF THE INVENTION

Accordingly, an object of the present invention is to provide a traction band with improved ground-engaging lugs that obviate the above-mentioned disadvantages.

Another object of the present invention is to provide a traction band which comprises more rigid ground-engaging lugs.

Still another object of the present invention is to provide a traction band which comprises more resistant ground-engaging lugs.

A further object of the present invention is to provide a traction band which is generally not heavier than a standard prior art traction band.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

According to one aspect of the present invention, a traction band with improved ground-engaging lugs is provided. The traction band comprises an endless body which extends along the longitudinal axis of the band. The body comprises an inner surface and an outer surface. The inner surface preferably comprises rows of drive lugs which cooperate with the sprocket wheel to transfer the power from the motor to the band. The inner surface can also comprises rows of holes wherein each two consecutives holes define a clip area which generally support a clip. The outer surface comprises a plurality of ground-engaging lugs which are generally transversely disposed along the longitudinal axis of the band.

According to a preferred embodiment of the present invention, the material forming the ground-engaging lugs is generally partially longitudinally displaced. In a preferred embodiment, the lug is formed in a I or H shape when viewed from the top. As a result, the ground-engaging lugs are more resistant, more rigid and improve the traction capabilities of the band without adding more lug material and thus, without increasing the weight of the band. The lugs, according to the present invention therefore generally improve the weight/rigidity ratio of the lugs. Similar results have also been obtained with lugs having a C-shape, O-shape or square shape. Other shapes which shall be described below have also shown similar performances.

According to a preferred embodiment, when the ground-engaging lug is viewed from the top, the bulk of the material that composes the lug is generally displaced in generally two longitudinally offset portions, joined by a connecting portion, in order to preferably obtain an “I” or “H” shaped lug.

Generally speaking, when viewed from the top, such lug has a shape reminiscent of the shape of a section of a steel I-beam.

When the lugs are in use, their base (the portion of the lug which is contact with the traction band) is subjected to extreme traction and compression forces. Overtime, the prior art lugs will break or at least be partially destroyed. By longitudinally displacing lug material away from the general center of the lug, where the forces are the lowest, to the outer edges, where the traction and compression forces are the highest, the resistance and rigidity of the lug are greatly improved without adding new material. Since each lug is more rigid, it has a lesser tendency to bend under the strain of the friction between the ground and the lug. This, in return, improves the traction capability of the band.

All these advantages are obtained without the addition of supplemental material and without generally altering the height and/or size of the lugs. This is achieved by displacing a portion of the lug material located generally in the center of the lug, where the forces are lesser to where the forces are the greatest, that is, away from the general center of the lug.

The invention accordingly comprises the furthers of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a partial top view of the traction band comprising a first embodiment of the ground-engaging lugs.

FIG. 2 is a partial side view of the traction band shown in FIG. 1.

FIG. 3 is a close-up top view of a portion of the traction band shown in FIG. 1.

FIG. 4 is an enlarged side view of the first embodiment of the lug of the present invention.

FIG. 5 is a close-up top view of a second embodiment of the present invention.

FIG. 6 is a close-up top view of a third embodiment of the present invention.

### DETAILED DESCRIPTION OF THE PREFERRED EMBODIMENTS

With reference to the annexed drawings, the preferred embodiments of the present invention will be herein described for indicative purposes and by no means as of limitation.

The following description will be made with respect to a traction band for a snowmobile. However, it is to be understood that traction bands used on other track-laying vehicles shall comprise characteristics which can differ from the one set forth here. Still, the ground-engaging lugs of the present invention can be used on other types of traction bands without departing from the scope of the invention which will be defined in the appended claims.

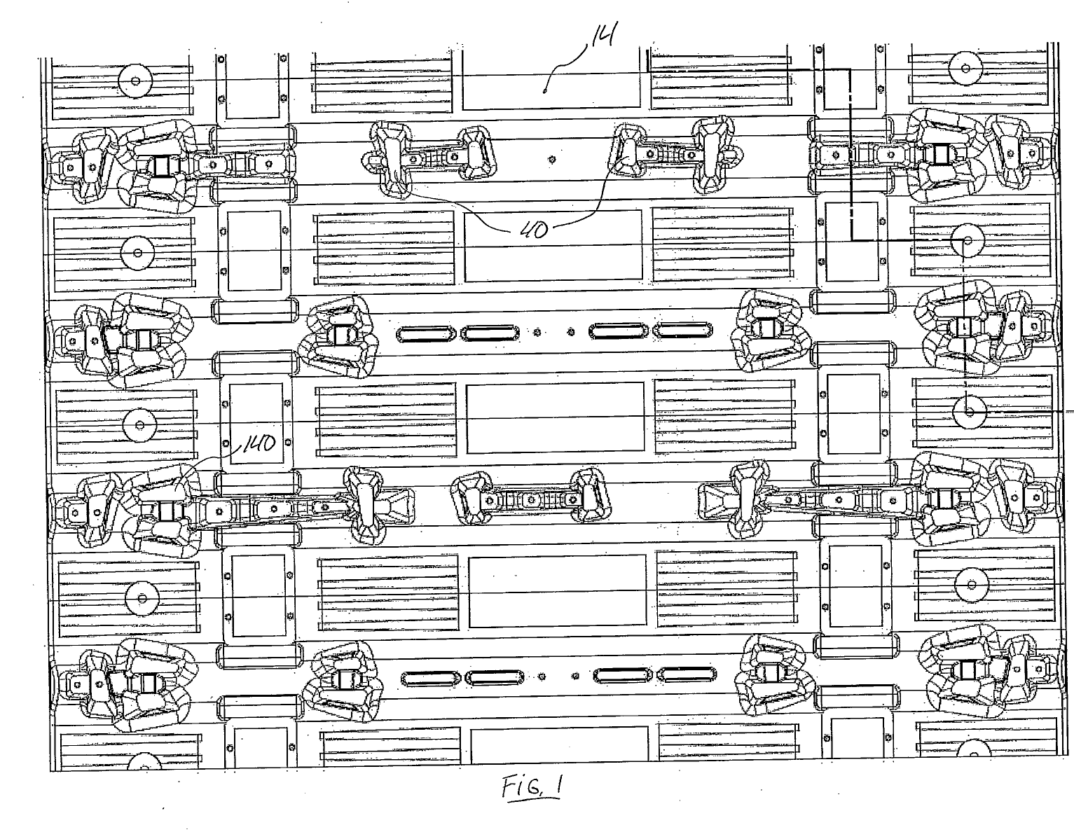

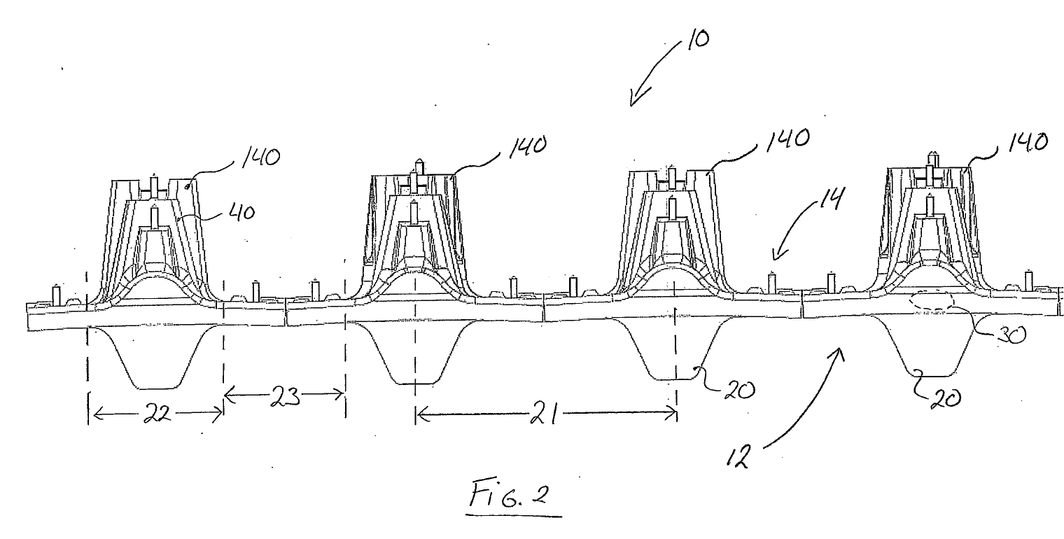

Referring now to FIGS. 1 and 2, we can see partial top and side views of a traction band 10 which comprises a sprocket engaging surface 12 and a ground-engaging surface 14. The sprocket engaging surface 12 preferably comprises rows of drive lugs 20 which are adapted to cooperate with the sprocket wheel (not shown) of the vehicle in order to transmit power from the motor (not shown) to the traction band 10.

The traction band 10 also preferably comprises a plurality of stiffeners or reinforcing rods 30 (shown in dotted lines), transversely embedded into the band 10 and generally evenly spaced. The stiffeners 30 are generally longitudinally aligned with the drive lugs 20. The space between two consecutive stiffeners and thus, drive lugs, generally defines the pitch 21 of the traction band.

The outer or ground-engaging surface 14 of the band 10 comprises a plurality of ground-engaging lugs 40 and 140 which are generally transversely disposed. The lugs 40 and 140 are generally and preferably disposed above the embedded stiffeners 30. Each two consecutive lug zones 22 are generally separated by a generally flat and lug-less zone 23. The choice of the pattern of the traction lugs 40 and 140 is important and has an impact on the performance of the traction band. However, the pattern of the traction lugs 40 and 140 is not the object of the present invention and the pattern shown in FIGS. 1-3 is for illustrative purpose only and in no way limitative in nature.

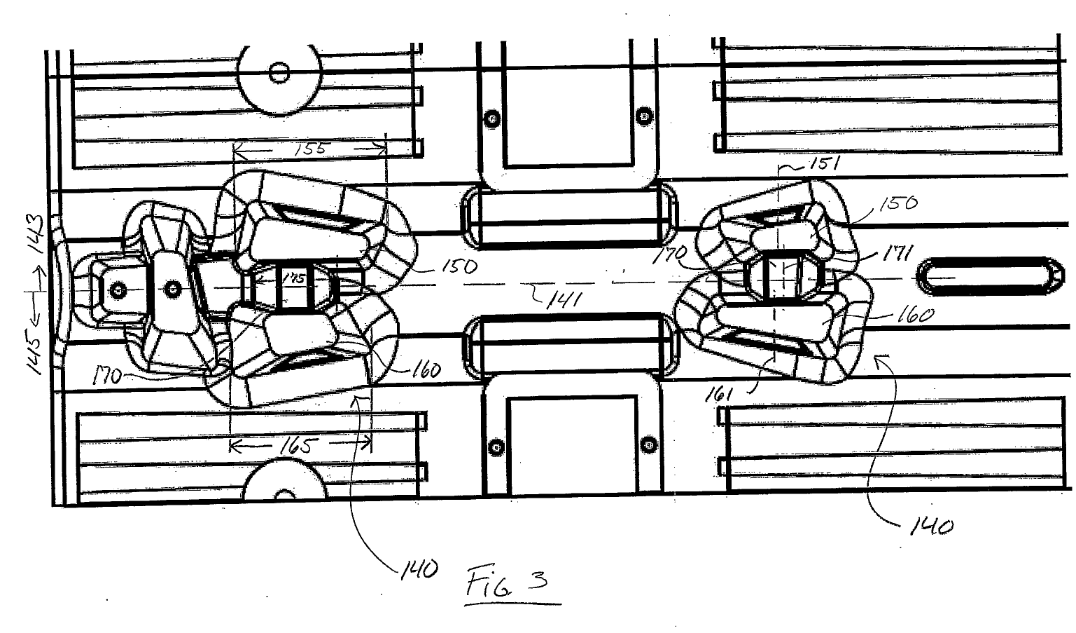

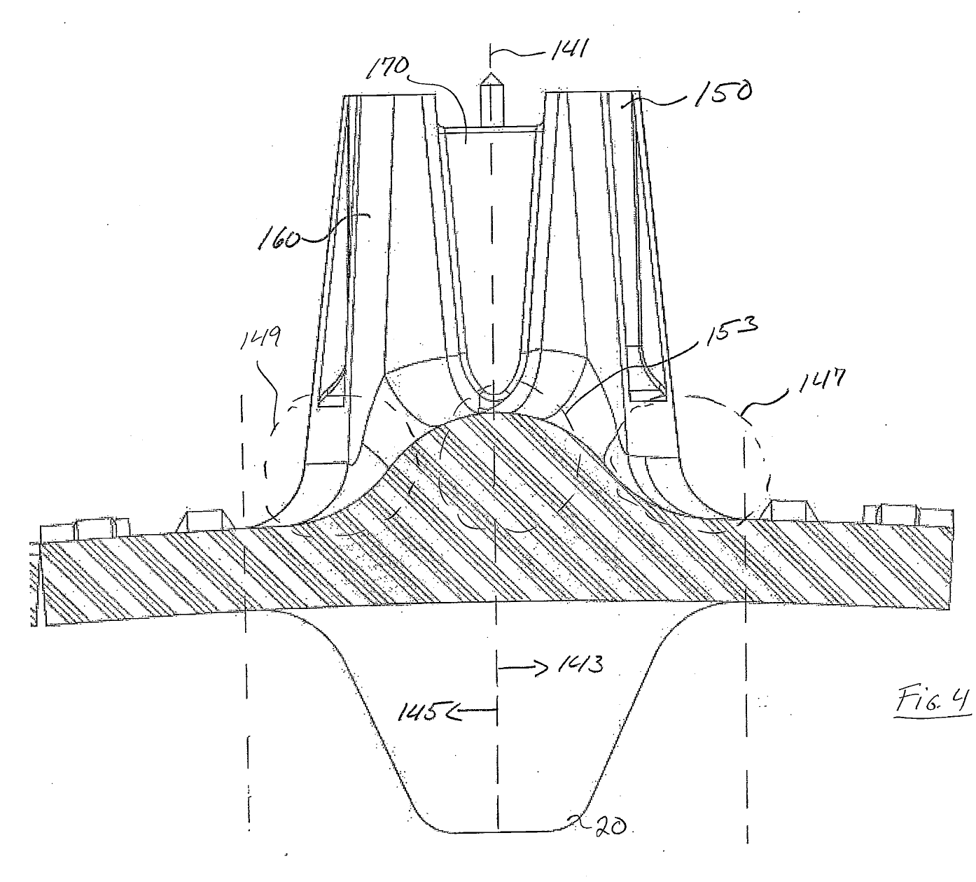

The preferred embodiment of the lug of the present invention is generally indicated as 140. Lugs 140 are best viewed in FIG. 3 where they have been enlarged for better clarity. The zone 22 where the lugs 140 are disposed comprises a generally central lateral axis 141 which divides the zone 22 into two sides 143 and 145 (see also FIG. 4). The skilled addressee will understand that even though it is preferred that the lugs 140 (and 40) be placed over the stiffeners 30, this is not an absolute requirement. Therefore, the central lateral axis 141 is to be used to clarify the description and not as a limitation.

According to the present invention, the lugs 140 comprises a first portion 150, longitudinally displaced with respect with the central axis 141 and extending generally laterally. The first portion 150 also comprises a central longitudinal axis 151 generally located at the middle of the portion 150.

As used herein, the term “central longitudinal axis” refers to an longitudinal (in relation to the traction band) axis passing through the center of a structure.

The lugs 140 also comprise a second portion 160 longitudinally displaced with respect to the central axis 141. The second portion also generally extends laterally. As for first portion 150, second portion 160 also comprises a central longitudinal axis 161 located in its middle.

Whereas the first portion 150 is longitudinally displaced on first side 143, second portion 160 is longitudinally displaced on second side 145.

Finally, the first portion 150 and second portion 160 are joined by a third portion 170 which is located between and adjacent to first and second portions 150 and 160 and which overlaps the axis 141. The third portion thus longitudinally extends on both sides of the axis 141. The third portion also comprises a central longitudinal axis 171.

As best seen in FIG. 3, the width 155 of the first portion 150 and the width 165 of the second portion 160 are greater that the width 175 of the third portion 170. Also, the skilled addressee will observe that first portion 150 and second portion 160 are generally larger than the third portion 170. Still, the width 155 of the first portion 150 need not to be equal to the width 165 of the second portion 160. In fact, it could be possible to find, on the same track 10, some lugs 140 with portions 150 and 160 of equal width and some other lugs 140 with portions 150 and 160 of different width.

In order to obtain the best results, it is preferable to provide lugs 140 with a generally I-shape or H-shape when viewed from the top. Therefore, the central longitudinal axis 151, 161 and 171 should preferably be substantially aligned. However, depending on the exact shape of each portions, lugs 140, wherein the axis 151, 161 and 171, of the first portion 150, second portion 160 and third portion 170 respectively, are not perfectly aligned or are offset, could be contemplated without departing from the scope of the invention. Indeed, a variant wherein the axes are not aligned shall be described below.

Moreover, should it be required, a plurality of third portions 170 could be used to join first portion 150 and second portion 160. Each of the plurality of portions 170 would understandably be generally laterally spaced from each other. For example, a fourth portion (not shown), similar to the third portion 170 but laterally offset could be added to the lug 140. This variant would generally have a square (or rectangle) shape, an oval shape or an O-shape.

The reason for this novel design is that when traction lugs 140 are in use, they are subjected to flexion strain which will tend to bend the lugs 140. As they bend, traction forces and compression forces are applied to the base of the lugs 140 and principally at the outer edges 147 and 149 (FIG. 4). However, almost no force is applied to the central portion 153 of the lug 140.

The lug material located on the central portion 153 is thus less strained.

The lugs 140 have the particularity that the bulk of the lug material (first portion 150 and second portion 160) is displaced at the outer edges 147 and 149 where the compression and traction forces are the highest. In the center portion 153, where less forces are applied, the lugs 140 comprises less lugs material (third portion 170). This particular shape of lugs 140 therefore provides a better rigidity to weight ratio since the lugs 140 are more rigid without being larger. Lug material has in fact be allocated to where the forces are the highest.

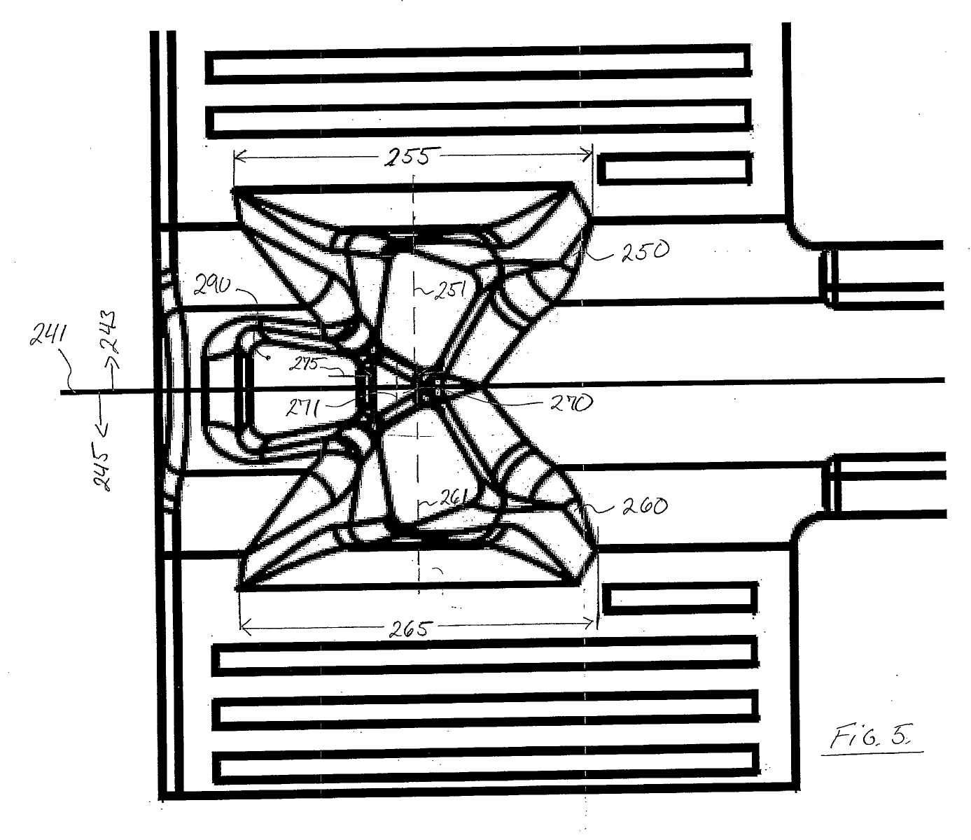

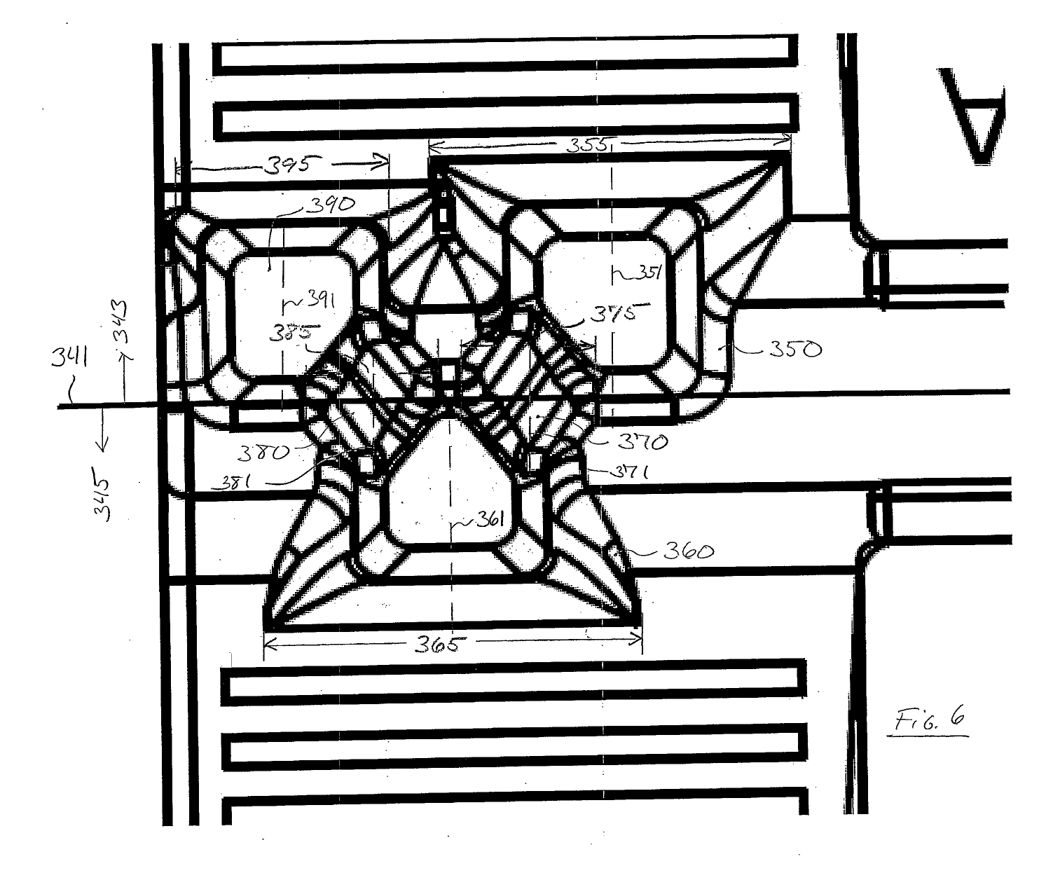

Even though a preferred embodiment has just been described, it is to be understood that the concept of displacing lug material to where the forces are highest can be generalized and embodied in multiple variants. Such variants are shown in FIGS. 5 and 6.

In FIG. 5, the lug 240 is generally divided in two by a lateral axis 241. The axis 241 defines a first side 243 and a second side 245. The lug 240 comprises a first portion 250, generally located on the first side 243, a second portion 260, generally located on the second side 245 and a third portion 270, generally located in the center and overlapping the axis 241. The third portion 270 generally connects the first portion 250 and the second portion 260. However, the skilled addressee will understand that in lug 240, the third portion 270 could be removed and the first 250 and second 260 portions made to contact each other directly near the axis 241. A fourth portion 290 could be added, as shown in FIG. 5 but is not absolutely necessary.

In FIG. 5, the first portion 250 and second portion 260 have generally triangular shape when viewed from the top. These portions are thus different than the ones shown in FIG. 3 which are generally laterally extending. In fact, in the embodiment of FIG. 5, the displacement of lug material away from the center is more gradual than in the embodiment of FIG. 3. However, the bulk of lug material is still substantially away from the axis 241.

The embodiment shown in FIG. 6 is slightly different. This embodiment 340 is also divided in two by a lateral axis 341 which defines a first side 343 and a second side 345. The lug 340 comprises a first portion 350 located on the first side 343, a second portion 360, located on the second side 345 and a third portion 370 located generally in the center, overlapping the axis 341. The third portion 370 is located between and adjacent to first portion 350 and second portion 360. Whereas in the embodiment 140 of FIG. 3, the first portion 150, the second portion 160 and the third portion 170 were generally aligned, in this lug 340, the first portion 350, the second portion 360 and the third portion 370 are generally laterally offset.

Furthermore, it is contemplated, as best shown in FIG. 6, to add a fourth portion 390 and a fifth portion 380. The fourth portion 390 is generally located on the first side. As for the fifth portion 380, it acts as the third portion 370, in linking the second portion 360 to the fourth portion 390. As for portions 350, 360 and 370, portions 360, 380 and 390 are generally offset. In FIG. 6, the lug 340 therefore generally defines a “V” shape.

Yet, with or without portions 380 and 390, the lug 340 expresses the same concept of lug material displacement. Indeed, first portion 350 and second portion 360 are generally located away from the axis 341 and are larger than central portion 370. Thus, the lug material is allocated where the forces are the highest as in the first and second embodiment.

Although the present traction band has been described with a certain degree of particularity it is to be understood that the disclosure has been made by way of example only and that the present invention is not limited to the features of the embodiment(s) described and illustrated herein, but includes all variations and modifications within the scope and spirit of the invention as hereinafter claimed.

1. A traction band for use on a vehicle, said traction band comprising a longitudinally extending endless body, said body comprising an inner surface and an outer ground-engaging surface, said outer surface comprising a least one transversely disposed and outwardly projecting traction lug, said traction lug comprising:
a. a first portion, having a first width;
b. a second portion, having a second width;
wherein said first portion and said second portion are longitudinally offset.

2. A traction band as claimed in claim 1, wherein said first and said second portions are connected.

3. A traction band as claimed in claim 2, wherein said first and said second portions are connected via a third portion, located between and adjacent to said first portion and said second portion, said third portion having a third width that is less than said first width.

4. A traction band as claimed in claim 3, wherein said second width is greater than said third width.

5. A traction band for use on a vehicle, said traction band comprising a longitudinally extending endless body, said body comprising an inner surface and an outer ground-engaging surface, said outer surface comprising a least one transversely disposed and outwardly projecting traction lug, said traction lug being divided in at least two longitudinally offset portions by a substantially central axis, said axis defining a first side and a second side, said traction lug comprising:
a. a first portion, having a first width and longitudinally displaced from said axis on said first side;
b. a second portion, having a second width and longitudinally displaced from said axis on said second side;
c. a third portion, having a third width, located between and adjacent to said first and second portions;
wherein said first width and said second width are greater than said third width.

6. A traction band as claimed in claim 5 wherein said traction band comprises a plurality of said traction lug.

7. A traction band as claimed in claim 5 wherein said first width and said second width are substantially equal.

8. A traction band as claimed in claim 5 wherein said first width is greater than said second width.

9. A traction band as claimed in claim 5 wherein said second width is greater than said first width.

10. A traction band as claimed in claim 5 wherein said first portion has a first central longitudinal axis and said second portion has a second central longitudinal axis and wherein said first longitudinal axis and said second longitudinal axis are substantially laterally aligned.

11. A traction band as claimed in claim 5 wherein said first portion has a first central longitudinal axis, said second portion has a second central longitudinal axis and said third portion has a third central longitudinal axis and wherein said first longitudinal axis, said second longitudinal axis and said third longitudinal axis are substantially laterally aligned.

12. A traction band as claimed in claim 5 wherein said first portion has a first central longitudinal axis and said second portion has a second central longitudinal axis and wherein said first longitudinal axis and said second longitudinal axis are substantially laterally offset.

13. A traction band as claimed in claim 5 wherein said first portion has a first central longitudinal axis, said second portion has a second central longitudinal axis and said third portion has a third central longitudinal axis and wherein said first longitudinal axis, said second longitudinal axis and said third longitudinal axis are substantially laterally offset.

14. A traction band as claimed in claim 5 wherein said traction lug further comprises a fourth portion, having a fourth width, located between and adjacent to said first and second portions and wherein said first width and said second width are greater than said fourth width.

15. A traction band as claimed in claim 14 wherein said first portion has a first central longitudinal axis and said second portion has a second central longitudinal axis and wherein said first longitudinal axis and said second longitudinal axis are substantially laterally aligned.

16. A traction band as claimed in claim 14 wherein said first portion has a first central longitudinal axis, said second portion has a second central longitudinal axis, said third portion has a third central longitudinal axis and said fourth portion has a fourth central longitudinal axis and wherein said first longitudinal axis and said second longitudinal axis are substantially laterally aligned and wherein said third longitudinal axis and said fourth longitudinal axis are substantially laterally offset from each other and from said first longitudinal axis and said second longitudinal axis.
